(19) United States
(12) Patent Application Publication
(10) Pub. No.: US 2011/0087828 A1
(43) Pub. Date: Apr. 14, 2011

(54) METHOD FOR ENHANCING PERFORMANCE OF ACCESSING A FLASH MEMORY, AND ASSOCIATED MEMORY DEVICE AND CONTROLLER THEREOF

(76) Inventors: Chun-Kun Lee, Hsinchu County (TW); Jen-Wen Lin, Kaohsiung City (TW)

(21) Appl. No.: 12/646,985

(22) Filed: Dec. 24, 2009

(30) Foreign Application Priority Data
Oct. 9, 2009 (TW) 098134323

(51) Int. Cl. G06F 12/00; G06F 12/02

(52) U.S. Cl. 711/103; 711/E12.001; 711/E12.008

(57) ABSTRACT

A method for enhancing performance of accessing a Flash memory, which includes a plurality of blocks and is positioned in a memory device, includes: during writing data into the Flash memory, establishing/updating at least one linking table in a random access memory (RAM) of the memory device, wherein regarding the Flash memory, the linking table indicates linking relationships between logical addresses and physical addresses, or indicates linking relationships between physical addresses and logical addresses; and writing the linking table into the Flash memory only when it is detected that a flush cache command is sent from a host device. An associated memory device and a controller thereof are also provided, where the controller includes: a read only memory (ROM) arranged to store a program code; and a microprocessor arranged to execute the program code to control the access to the Flash memory.

### BACKGROUND OF THE INVENTION

1. Field of the Invention

The present invention relates to access to a Flash memory, and more particularly, to a method for enhancing performance of accessing a Flash memory, and to an associated memory device and a controller thereof.

2. Description of the Prior Art

As technologies of Flash memories progress in recent years, many kinds of portable memory devices, such as memory cards respectively complying with SD/MMC, CF, MS, and XD standards, are widely implemented in various applications. Therefore, the control of access to Flash memories in these portable memory devices has become an important issue.

Taking NAND Flash memories as an example, they can mainly be divided into two types, i.e. Single Level Cell (SLC) Flash memories and Multiple Level Cell (MLC) Flash memories. Each transistor that is considered a memory cell in SLC Flash memories only has two charge levels that respectively represent a logical value 0 and a logical value 1. In addition, the storage capability of each transistor that is considered a memory cell in MLC Flash memories can be fully utilized. More specifically, the voltage for driving memory cells in the MLC Flash memories is typically higher than that in the SLC Flash memories, and different voltage levels can be applied to the memory cells in the MLC Flash memories in order to record information of two bits (e.g. binary values 00, 01, 11, or 10) in a transistor that is considered a memory cell. Theoretically, the storage density of the MLC Flash memories may reach twice the storage density of the SLC Flash memories, which is considered good news for NAND Flash memory manufacturers who encountered a bottleneck of NAND Flash technologies.

As MLC Flash memories are cheaper than SLC Flash memories, and are capable of providing higher capacity than SLC Flash memories while the space is limited, MLC Flash memories have been a main stream for implementation of most portable memory devices on the market. However, various problems of the MLC Flash memories have arisen due to their unstable characteristics. Therefore, some suggestions are provided in response to these problems in the related art. Please note that a portion of the suggestions provided in the related art may cause some side effects. For example, the endurance of the MLC Flash memories may become lower, the performance may become worse, the reading/writing speed may decrease, the probability of the occurrence of reading/writing errors may increase, and some problems may occur when implementing certain kinds of portable memory devices, such as memory cards complying with the SD standards. Thus, a novel method is required for enhancing the control of data access to Flash memories, in order to enhance the overall performance of portable memory devices.

### SUMMARY OF THE INVENTION

It is therefore an objective of the claimed invention to provide a method for enhancing performance of accessing a Flash memory, and to provide an associated memory device and a controller thereof, in order to achieve the best overall performance of portable memory devices.

According to a preferred embodiment of the claimed invention, a method for enhancing performance of accessing a Flash memory is provided. The Flash memory comprises a plurality of blocks and is positioned in a memory device. The method comprises: during writing data into the Flash memory, establishing/updating at least one linking table in a random access memory (RAM) of the memory device, where regarding the Flash memory, the linking table indicates linking relationships between logical addresses and physical addresses, or indicates linking relationships between physical addresses and logical addresses; and writing the linking table into the Flash memory only when it is detected that a flush cache command is sent from a host device, where the linking table is utilized as reference for further access to the Flash memory.

While the method mentioned above is disclosed, an associated memory device is further provided. The memory device comprises: a Flash memory comprising a plurality of blocks; and a controller arranged to access the Flash memory and manage the plurality of blocks. In addition, during writing data into the Flash memory, the controller establishes/updates at least one linking table in a random access memory (RAM) of the memory device, where regarding the Flash memory, the linking table indicates linking relationships between logical addresses and physical addresses, or indicates linking relationships between physical addresses and logical addresses. Additionally, the controller writes the linking table into the Flash memory only when it is detected that a flush cache command is sent from a host device, where the linking table is utilized as reference for further access to the Flash memory.

While the method mentioned above is disclosed, a controller of a memory device is further provided, wherein the controller is utilized for accessing a Flash memory comprising a plurality of blocks. The controller comprises: a read only memory (ROM) arranged to store a program code; and a microprocessor arranged to execute the program code to control the access to the Flash memory and manage the plurality of blocks. In addition, during writing data into the Flash memory, the controller that executes the program code by utilizing the microprocessor establishes/updates at least one linking table in a random access memory (RAM) of the memory device, where regarding the Flash memory, the linking table indicates linking relationships between logical addresses and physical addresses, or indicates linking relationships between physical addresses and logical addresses. Additionally, the controller that executes the program code by utilizing the microprocessor writes the linking table into the Flash memory only when it is detected that a flush cache command is sent from a host device, where the linking table is utilized as reference for further access to the Flash memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a memory device according to a first embodiment of the present invention.

FIG. 2 is a flowchart of a method for enhancing performance of accessing a Flash memory according to an embodiment of the present invention.

FIG. 3 illustrates a normal shutdown checking table involved with the method shown in FIG. 2 according to an embodiment of the present invention.

### DETAILED DESCRIPTION

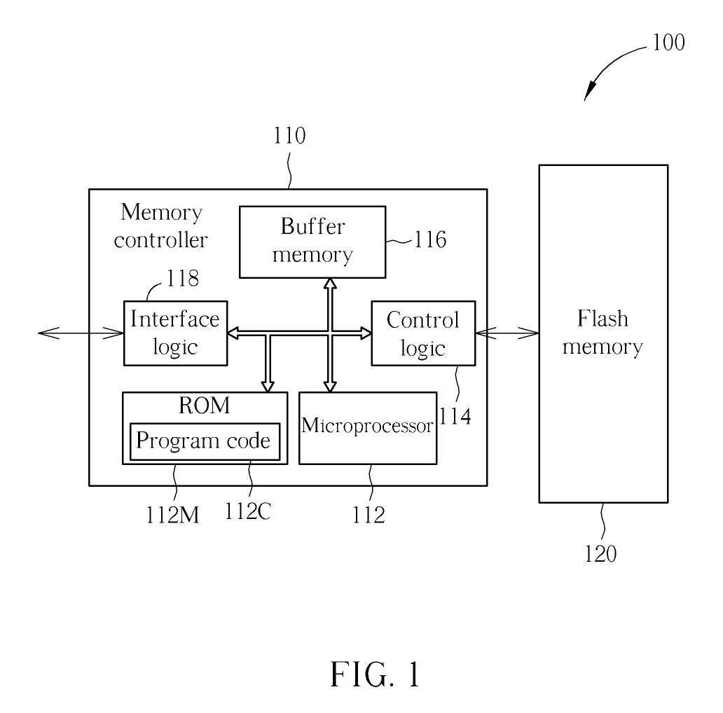

Please refer to FIG. 1, which illustrates a diagram of a memory device 100 according to a first embodiment of the present invention. In particular, the memory device 100 of this embodiment is a portable memory device, such as a memory card complying with SD/MMC, CF, MS, or XD standards. The memory device 100 comprises a Flash memory 120, and further comprises a controller arranged to access the Flash memory 120, where the aforementioned controller of this embodiment is a memory controller 110. According to this embodiment, the memory controller 110 comprises a microprocessor 112, a read only memory (ROM) 112M, a control logic 114, a buffer memory 116, and an interface logic 118. The ROM 112M is arranged to store a program code 112C, and the microprocessor 112 is arranged to execute the program code 112C to control the access to the Flash memory 120. Please note that, according to different variations of this embodiment, the program code 112C can be stored in the buffer memory 116 or any other memory.

Typically, the Flash memory 120 comprises a plurality of blocks, and the controller (e.g. the memory controller 110 that executes the program code 112C by utilizing the microprocessor 112) performs data erasure operations on the Flash memory 120 by erasing in units of blocks. In addition, a block can be utilized for recording a specific amount of pages, where the controller mentioned above performs data writing operations on the Flash memory 120 by writing/programming in units of pages.

In practice, the memory controller 110 that executes the program code 112C by utilizing the microprocessor 112 is capable of performing various control operations by utilizing the internal components within the memory controller 110. For example, the memory controller 110 utilizes the control logic 114 to control access to the Flash memory 120 (e.g. operations of accessing at least one block or at least one page), utilizes the buffer memory 116 to perform buffering operations for the memory controller 110, and utilizes the interface logic 118 to communicate with a host device.

According to this embodiment, in addition to accessing the Flash memory 120, the controller is capable of properly managing the plurality of blocks. More specifically, during writing data into the Flash memory 120, the controller establishes/updates at least one linking table in a random access memory (RAM) of the memory device 100 (e.g. the buffer memory 116 of the memory controller 110), where regarding the Flash memory 120, the linking table indicates linking relationships between logical addresses and physical addresses, or indicates linking relationships between physical addresses and logical addresses. More particularly, the aforementioned at least one linking table comprises at least one page linking table or at least one block linking table. For example, in a situation where the aforementioned at least one linking table comprises at least one page linking table, the page linking table indicates linking relationships between logical page addresses and physical page addresses, or indicates linking relationships between physical page addresses and logical page addresses. In another example, in a situation where the aforementioned at least one linking table comprises at least one block linking table, the block linking table indicates linking relationships between logical block addresses and physical block addresses, or indicates linking relationships between physical block addresses and logical block addresses.

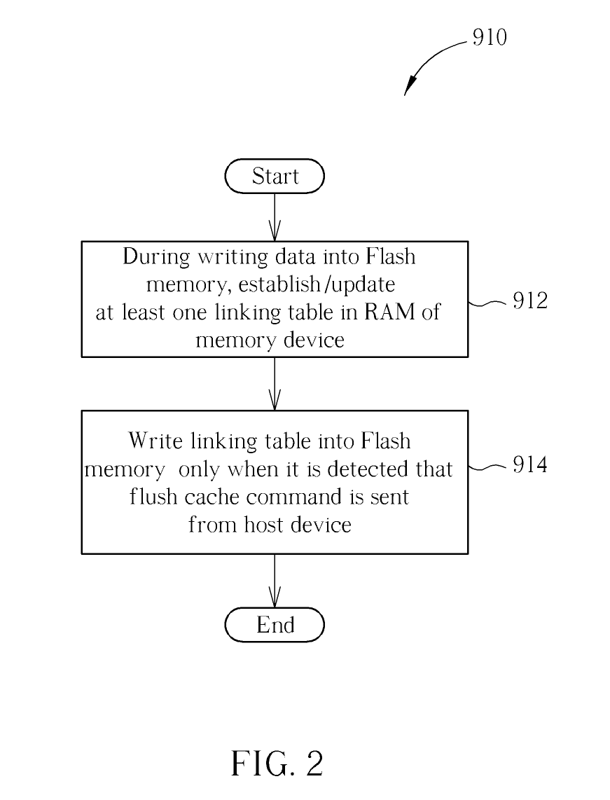

Please note that the aforementioned RAM can be the buffer memory 116 within the memory controller 110. This is for illustrative purposes only, and is not meant to be a limitation of the present invention. According to a variation of this embodiment, the aforementioned RAM can be any RAM outside the controller. In addition, in this embodiment, the controller writes the linking table into the Flash memory 120 only when it is detected that a flush cache command is sent from the host device, where the linking table is utilized as reference for further access to the Flash memory 120. In particular, the flush cache command is a command that should be sent out when the host device is going to perform a shutdown operation, where the flush cache command is typically utilized for notifying all storage devices connected with the host device (e.g. hard disk drives (HDDs), optical disc drives, Universal Serial Bus (USB) Flash disks, or various kinds of memory cards) to respectively write the data in their own buffers into their own storage media. In an embodiment, the flush cache command can be the E7h command in Advanced Technology Attachment Packet Interface (ATAPI) specifications. Related details are further described as follows by referring to FIG. 2.

FIG. 2 is a flowchart of a method 910 for enhancing performance of accessing a Flash memory according to an embodiment of the present invention. The method can be applied to the memory device 100 shown in FIG. 1, and more particularly, to the controller mentioned above (e.g. the memory controller 110 that executes the program code 112C by utilizing the microprocessor 112). In addition, the method can be implemented by utilizing the memory device 100 shown in FIG. 1, and more particularly, by utilizing the controller mentioned above. The method 910 is described as follows.

In Step 912, during writing data into the Flash memory 120, the aforementioned controller (e.g. the memory controller 110 that executes the program code 112C by utilizing the microprocessor 112) establishes/updates at least one linking table in the aforementioned RAM (and more particularly, the buffer memory 116 of the memory controller 110), where regarding the Flash memory 120, the linking table indicates linking relationships between logical addresses and physical addresses, or indicates linking relationships between physical addresses and logical addresses.

In Step 914, the controller writes the linking table into the Flash memory 120 only when it is detected that the flush cache command is sent from the host device, where the linking table is utilized as reference for further access to the Flash memory 120. In this embodiment, before detecting the flush cache command from the host device, the controller prevents writing the linking table into the Flash memory 120, in order to reduce the probability of occurrence of low overall performance.

According to this embodiment, during a startup procedure of the memory device 100, the controller can obtain a source version of the linking table (if exists) from the Flash memory 120, where the source version is utilized as an initial version of the linking table in the RAM after the startup procedure. Thus, in Step 914, writing the linking table into the Flash memory 120 represents restoring the latest version of the linking table (i.e. the latest version of the linking table at that time) into the Flash memory 120. This is for illustrative purposes only, and is not meant to be a limitation of the present invention. According to a variation of this embodiment, in a situation where there is not any source version of the linking table in the Flash memory 120, the controller can directly establish the linking table in the RAM. According to another variation of this embodiment, after a startup procedure of the memory device 100, the controller can obtain a source version of the linking table (if exists) from the Flash memory 120, where the source version is utilized as an initial version of the linking table in the RAM after the startup procedure.

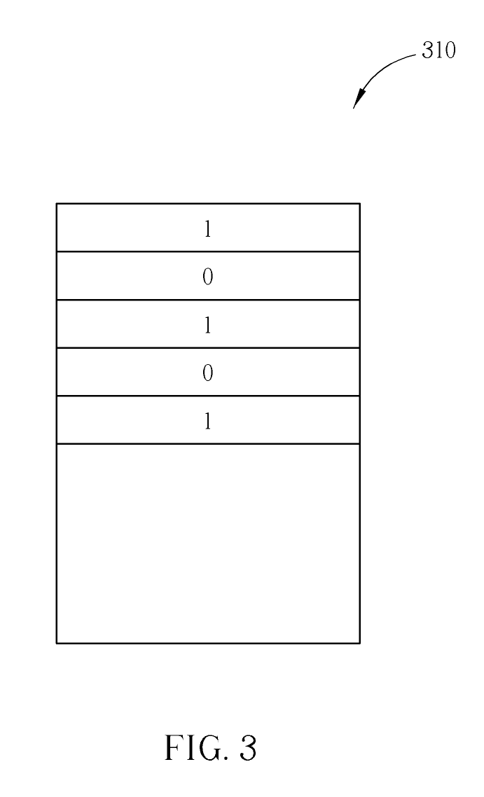

In addition, the controller can establish/update at least one normal shutdown checking table in the Flash memory 120, and the normal shutdown checking table indicates whether the latest version of the linking table is successfully written into the Flash memory 120 during the latest shutdown. Please refer to FIG. 3, which illustrates the normal shutdown checking table 310 involved with the method 910 shown in FIG. 2 according to an embodiment of the present invention. In a situation where a predetermined criterion is satisfied, the controller writes a first logic value (e.g. a logic value 0) into the normal shutdown checking table 310 shown in FIG. 3, where the first logic value represents that the linking table has been changed or will be changed. For example, the predetermined criterion of this embodiment may represent the startup of the memory device 100. Thus, whenever the memory device 100 starts up, the controller writes the first logic value into the normal shutdown checking table 310. This is for illustrative purposes only, and is not meant to be a limitation of the present invention. According to a variation of this embodiment, the predetermined criterion may represent that the memory device 100 receives a write command from the host device. Thus, whenever the memory device 100 receives a write command from the host device, the controller writes the first logic value into the normal shutdown checking table 310 shown in FIG. 3.

According to this embodiment, in a situation where the latest version of the linking table is successfully restored into the Flash memory 120, the controller writes a second logic value (e.g. a logic value 1) into the normal shutdown checking table 310, where the second logic value is utilized for indicating that the controller has completed the restoring operation of the latest version. As a result, according to whether the latest written value in the normal shutdown checking table 310 is the first logic value or the second logic value, the controller can determine whether to recover the latest version of the linking table. More specifically, whenever the memory device 100 starts up, once the latest written value in the normal shutdown checking table 310 is the first logic value, which means the controller has not completed the restoring operation of the latest version, the controller determines to recover the latest version of the linking table; otherwise (i.e. the latest written value in the normal shutdown checking table 310 is the second logic value), the controller determines that it is not required to recover the latest version of the linking table since the controller has completed the restoring operation of the latest version.

Please note that, in this embodiment, the first logic value is the logic value 0, and the second logic value is the logic value 1. This is for illustrative purposes only, and is not meant to be a limitation of the present invention. According to a variation of this embodiment, the first logic value is the logic value 1, and the second logic value is the logic value 0. According to another variation of this embodiment, the first and the second logic values can be replaced by other values.

It is an advantage of the present invention that, the controller writes the linking table into the Flash memory 120 only when it is detected that the flush cache command is sent from the host device, rather than writing into the Flash memory 120 at any time in response to any change of the linking table. As a result, the present invention can reduce the probability of occurrence of low overall performance in the memory device 100. More particularly, in a situation where extremely frequent data access is encountered, the present invention can still achieve the best overall performance of portable memory devices.

Those skilled in the art will readily observe that numerous modifications and alterations of the device and method may be made while retaining the teachings of the invention.

What is claimed is:

1. A method for enhancing performance of accessing a Flash memory, the Flash memory comprising a plurality of blocks and being positioned in a memory device, the method comprising:
during writing data into the Flash memory, establishing/updating at least one linking table in a random access memory (RAM) of the memory device, wherein regarding the Flash memory, the linking table indicates linking relationships between logical addresses and physical addresses, or indicates linking relationships between physical addresses and logical addresses; and
writing the linking table into the Flash memory only when it is detected that a flush cache command is sent from a host device, wherein the linking table is utilized as reference for further access to the Flash memory.

2. The method of claim 1, further comprising:
during or after a startup procedure of the memory device, obtaining a source version of the linking table from the Flash memory, wherein the source version is utilized as an initial version of the linking table in the RAM after the startup procedure;
wherein writing the linking table into the Flash memory represents restoring a latest version of the linking table into the Flash memory.

3. The method of claim 1, further comprising:
establishing/updating at least one normal shutdown checking table in the Flash memory, wherein the normal shutdown checking table indicates whether a latest version of the linking table is successfully written into the Flash memory during a latest shutdown.

4. The method of claim 3, further comprising:
in a situation where a predetermined criterion is satisfied, writing a first logic value into the normal shutdown checking table, wherein the first logic value represents that the linking table has been changed or will be changed;
in a situation where the latest version of the linking table is successfully restored into the Flash memory, writing a second logic value into the normal shutdown checking table; and
according to whether a latest written value in the normal shutdown checking table is the first logic value or the second logic value, determining whether to recover the latest version of the linking table.

5. The method of claim 4, wherein the predetermined criterion represents a startup of the memory device.

6. The method of claim 4, wherein the predetermined criterion represents that the memory device receives a write command from the host device.

7. The method of claim 1, wherein the memory device comprises a controller arranged to access the Flash memory and manage the plurality of blocks; and the RAM is a buffer memory within the controller.

8. A memory device, comprising:
a Flash memory comprising a plurality of blocks; and
a controller arranged to access the Flash memory and manage the plurality of blocks, wherein during writing data into the Flash memory, the controller establishes/updates at least one linking table in a random access memory (RAM) of the memory device, and regarding the Flash memory, the linking table indicates linking relationships between logical addresses and physical addresses, or indicates linking relationships between physical addresses and logical addresses;
wherein the controller writes the linking table into the Flash memory only when it is detected that a flush cache command is sent from a host device, and the linking table is utilized as reference for further access to the Flash memory.

9. The memory device of claim 8, wherein during or after a startup procedure of the memory device, the controller obtains a source version of the linking table from the Flash memory, and the source version is utilized as an initial version of the linking table in the RAM after the startup procedure; and writing the linking table into the Flash memory represents restoring a latest version of the linking table into the Flash memory.

10. The memory device of claim 8, wherein the controller establishes/updates at least one normal shutdown checking table in the Flash memory, and the normal shutdown checking table indicates whether a latest version of the linking table is successfully written into the Flash memory during a latest shutdown.

11. The memory device of claim 10, wherein in a situation where a predetermined criterion is satisfied, the controller writes a first logic value into the normal shutdown checking table, wherein the first logic value represents that the linking table has been changed or will be changed; in a situation where the latest version of the linking table is successfully restored into the Flash memory, the controller writes a second logic value into the normal shutdown checking table; and according to whether a latest written value in the normal shutdown checking table is the first logic value or the second logic value, the controller determines whether to recover the latest version of the linking table.

12. The memory device of claim 11, wherein the predetermined criterion represents a startup of the memory device.

13. The memory device of claim 11, wherein the predetermined criterion represents that the memory device receives a write command from the host device.

14. The memory device of claim 8, wherein the RAM is a buffer memory within the controller.

15. A controller of a memory device, the controller being utilized for accessing a Flash memory comprising a plurality of blocks, the controller comprising:
a read only memory (ROM) arranged to store a program code; and
a microprocessor arranged to execute the program code to control the access to the Flash memory and manage the plurality of blocks, wherein during writing data into the Flash memory, the controller that executes the program code by utilizing the microprocessor establishes/updates at least one linking table in a random access memory (RAM) of the memory device, and regarding the Flash memory, the linking table indicates linking relationships between logical addresses and physical addresses, or indicates linking relationships between physical addresses and logical addresses;
wherein the controller that executes the program code by utilizing the microprocessor writes the linking table into the Flash memory only when it is detected that a flush cache command is sent from a host device, and the linking table is utilized as reference for further access to the Flash memory.

16. The controller of claim 15, wherein during or after a startup procedure of the memory device, the controller that executes the program code by utilizing the microprocessor obtains a source version of the linking table from the Flash memory, and the source version is utilized as an initial version of the linking table in the RAM after the startup procedure; and writing the linking table into the Flash memory represents restoring a latest version of the linking table into the Flash memory.

17. The controller of claim 15, wherein the controller that executes the program code by utilizing the microprocessor establishes/updates at least one normal shutdown checking table in the Flash memory, and the normal shutdown checking table indicates whether a latest version of the linking table is successfully written into the Flash memory during a latest shutdown.

18. The controller of claim 17, wherein in a situation where a predetermined criterion is satisfied, the controller that executes the program code by utilizing the microprocessor writes a first logic value into the normal shutdown checking table, wherein the first logic value represents that the linking table has been changed or will be changed; in a situation where the latest version of the linking table is successfully restored into the Flash memory, the controller that executes the program code by utilizing the microprocessor writes a second logic value into the normal shutdown checking table; and according to whether a latest written value in the normal shutdown checking table is the first logic value or the second logic value, the controller that executes the program code by utilizing the microprocessor determines whether to recover the latest version of the linking table.

19. The controller of claim 18, wherein the predetermined criterion represents a startup of the memory device.

20. The controller of claim 18, wherein the predetermined criterion represents that the memory device receives a write command from the host device.
